(19) United States
(12) Patent Application Publication
(10) Pub. No.: US 2014/0008285 A1
(43) Pub. Date: Jan. 9, 2014

(54) PLEATED FILTER

(71) Applicants: JOHN E. NOHREN, JR., St. Petersburg, FL (US); Brad Mierau, Tampa, FL (US)

(72) Inventors: JOHN E. NOHREN, JR., St. Petersburg, FL (US); Brad Mierau, Tampa, FL (US)

(73) Assignee: IN-TEC WATER PRODUCTS, LLC, St. Petersburg, FL (US)

(21) Appl. No.: 13/543,990

(22) Filed: Jul. 9, 2012

(51) Int. Cl. B01D 63/14

(52) U.S. Cl. 210/321.77; 210/493.5; 210/489; 210/474

(57) ABSTRACT

A cylindrical pleated filter of charged layer membrane filter material is constructed with minimized filter occlusion and surface area where the filter diameter, a number of filter pleats and pleat width results in the outer pleat apex included angle of each pleat being at least 10-degrees. Other embodiments and the relationship between filter occlusion and performance of a cylindrical pleated filter of charged layer membrane filter material and filter diameter, number of filter pleats and pleat width is part of this disclosure.

### FIELD OF THE INVENTION

The present invention relates generally to pleated filters and improvements in pleated filter performance. In particular, and in a representatively illustrated embodiment, the present invention relates to improved pleated cylindrical filter constructions of charged layer membrane filter material having minimized pleat occlusion and minimized filter surface area with maximized filter performance.

### BACKGROUND OF THE INVENTION

There is a worldwide need for portable water filters to filter water of an unknown microbial quality in order to render the water safe to drink. The World Health Organization has estimated as many as 3.4-million people each year die from waterborne disease, of which children are a significant percentage. For example, in North America, the predominant biological contaminant in municipal water supplies is Cryptosporidium because of its resistant to chlorine. Likewise, surface waters, such as streams, are infested with Guardia Lamblia. Cost and simplicity are major driving factors in bringing a product to decontaminate water to the developing countries as well as to the industrialized world.

Because of their relative low cost, chlorine and/or iodine are conventionally used as biocide additives in drinking water to reduce biological contamination of the water. There are many drawbacks to using chlorine or iodine in water purification. One, it has been determined that extended use of iodine to treat water for biological contamination presents a health hazard to the thyroid. Another problem with the use of iodine or chlorine additives in water purification is the need to allow a minimum contact time between the iodine or chlorine and the water being treated. In some instances as long as thirty-minutes may be required prior to rendering the water safe to drink.

In recent years the field of portable water filtration, and particularly, in the area of portable, filtered drink containers, has experienced a significant interest in providing products aimed at providing a solution to the needs and problems discussed above. Various products, each achieving different levels of success, have been developed for the purpose of reducing water contamination.

Charged Layer Membrane (CLM) filter material is a relatively new type of filter material that has recently been used in the manufacture of pleated cylindrical filter cartridges for the purpose of flow-through filtration in portable drinking containers. A description of CLM filter material can be found in U.S. Pat. Nos. 7,390,343 and 6,838,005, the entirety of each are incorporated herein by reference.

Advantages of charged layer membrane filter media in portable, filter water devices include the ability to treat water for biological contamination without the use of iodine or chlorine, while providing a free flow of treated water with minimal pressure required by the user. Additionally, filter cartridges of charged layer membrane media may include powdered activated carbon within the internal matrix of the media, thereby eliminating a requirement of a separate carbon element to treat the water.

Despite the promising filtering performance of CLM filter material, the use of the filter material in pleated cylindrical filter cartridges has unexpectedly experienced limited success. Additionally, the media is relatively expensive when compared to other traditional filter media types. Accordingly, due to the expensive nature of the CLM media and its limited success in pleated cylindrical filter cartridges, the media is not widely utilized. And even when the CLM filter material is utilized the resulting product is expensive and not available to the general consumer.

Accordingly, there is a need for high performing cylindrical pleated filters made of CLM filter material for the purpose of filtering drinking water that meets established standards, such as the standards provided by the environment protection agency, to qualify as a microbial filter or purifier, and which is not cost prohibitive to the average consumer. More particularly, there is a need for a cylindrical pleated filter made of CLM filter material having a relatively small filter diameter for use in filtering drinking water in portable drinking systems, such as sports bottles, and the like which meets these needs.

### SUMMARY OF THE INVENTION

Unrecognized problems heretofore in cylindrical pleated filters of Charged Layer Membrane (CLM) filter material and the manufacture of the same affecting the performance of cylindrical pleated filters of CLM material are addressed and solved by embodiments of the present invention that are discussed herein.

The initial experience with CLM filter media in a pleated cylindrical form suitable for use as a filter in a portable drinking device, such a sports bottle or hydration pack, unexpectedly failed to meet anticipated performance based upon published test sheet stock results of the CLM filter media, and were far removed from being able to qualify as a microbial purifier.

The initial sports bottle filter was 43 mm in diameter, by 21 mm in length and included 30 pleats of 11 mm depth. The performance of pleated filter elements fabricated from commercially available media was lower than the test results reported for flat sheets of this media, prompting an analysis of the sensitivity of the performance to the physical characteristics of the filters induced by the manufacturing process as well as mode of application.

An unrecognized problem became apparent that in the quest for maximum filter surface area the pleats are functionally compressed one against the other. As a result resistance to flow through much of the surface area is increased, and flow is concentrated through the apex's of the internal pleat folds, hence increasing the velocity of water through a reduced area.

Charged membrane filters function less by size exclusion of contaminant particles by pore size in the membrane and more by the overlap of the surface charges. The overlap of these charges provides an effective pore radius which is much smaller than the actual pore size of the membrane. As such, retention of particles in the membrane by ion exchange and charge attraction is sensitive to flow rate and may be subject to charge saturation. Increasing flow through the inner crease of the pleat therefore affects filter performance both because of ionic effects and the fact that damage to the membrane may occur here in the pleating process. Further, when flow through the entire otherwise available surface is retarded due to occlusion, media and hence cost is wasted.

A study was conducted to isolate the causes that precluded obtaining the same test results with pleated product configurations, when compared with those reported tests that were obtained from flat supported discs of the media in the laboratory. Three problems surfaced, the first of which was relative to the apex of the pleat and the second was the reduction of functional surface area as a result of the opposing pleat sides being forced to be in contact as a result of too many pleats in a given diameter, and lastly pin holes that occasionally formed in the sonically welded joint as a result of burn through.

It was discovered the filtering performance of cylindrical pleated filters of CLM filter material is directly related to the filter diameter, the number of filter pleats and also the width of each filter pleat as will be described in further detail below. It is important to understand this relationship is not directed to filter performance degrading overtime as a result of contaminate preclusion of the filter material, but rather the performance of the filter when initial put into service.

Broadly, these deficiencies were addressed by reducing the pleats and opening the outer pleat apex angles (the acute angle formed by the crease of the pleats on the outside diameter of the filter) as will be further discussed. In embodiments of the present invention the pleating operation has been modified to reduce pleat apex stress, and reduce the number of filter pleats opening the outer pleat's apex angle. This has the effect of allowing a smaller surface area to function at a higher efficiency with a fewer number of pleats.

For filters with a 31 mm diameter and a 7 mm pleat depth it was determined that performance increased by decreasing the number of pleats to between 24 preferably, and 30. Stress at the outer pleat apex is higher at reduced outer pleat angles, and is a function of the filter diameter, number of pleats and the pleat width. For this particular 31 mm diameter filter, reducing the number of pleats to between 24 and 30 resulted in outer pleat apex angles between 18.3 and 14.7-degrees.

Reducing the number of pleats has the effect of reducing the total surface area for a given filter diameter and length provided there is no change in the individual pleat width. However, once increased to an outer apex angle equal or great than 21-degrees it is generally acceptable to increase the filter length to compensate for the reduction in pleat number at a fixed pleat width, subject to manufacturing considerations. However, generally speaking the most effective means of increasing surface area is by increasing the pleat width as it does not increase the internal or external pleat apex area but does affect the outer apex angles. Another means of increasing surface area is to increase the filter diameter together with increased pleat width allowing a reduction in pleat numbers without loss of effective surface area.

Also by eliminating the customarily used inner center filter support tube it becomes more practical to increase the width of the individual pleats to obtain the desired surface area. In doing so we find it possible to achieve still fewer pleats, opening the outer apex angle further enhancing free flow through the membrane utilizing the full surface area while concurrently placing less stress upon the fewer apex's of the pleats within the media.

While discussion herein center on two principal filter diameters the same is true for the range of portable Sport Bottle products with filter diameters between 21 mm and 49 mm and larger. For independent hand held devices the diameter can also range down to 12 mm when configured as a straw with a normal length of 120-230 mm, and diameters as large as the orifice in the top of any container. For in-line filtration for use with hydration packs lengths of up to 6 inches, (152 mm) and diameters of 1.5 inches (40 mm) are most practical though not limiting. When used in yachts or motor homes there is normally less constraints upon size. Thus, diameters as large as 4 inches-6 inches, or greater, with longer appropriate lengths are feasible.

The filters herein may be adapted to various configurations while remaining within the scope of the invention for use with a portable product such as a sport bottle or as an external assembly for use in conjunction with hydration packs as well as standalone in-line filters for use in yachts and recreational vehicles. The major difference being in the housings and filter lengths, surface area of the media employed, as well as the means of attachment. The filter for use in a sport type bottle is preferably connected by a thread type fitting which may be tightened against a seal ring whereas the in-line filters are attached within a feed hose or line and may be retained by hose clamps. Embodiments of cylindrical pleated filters of CLM material and housings thereof are more fully described below.

To achieve these and other advantages, in general, in one aspect, a filter element is provided. The filter element is a cylindrical pleated filter of charged layer membrane filter material wherein the outer pleat apex included angle of each pleat is at least 10-degrees and the width of each pleat is between 6 and 31% of the filter diameter.

In embodiments the outer pleat apex included angle of each pleat is at least 13-degrees. In embodiments the filter diameter is 31 mm and includes 30 or less pleats. In further embodiments the filter diameter is 49 mm and includes 36 or fewer pleats.

In an embodiment the filter element further includes a housing containing the cylindrical pleated filter of charged layer membrane filter material. The filter element may also further include a tube positioned interiorly of the cylindrical pleated filter of charged layer membrane filter material and connected to the housing so as to prevent the application of torque to the cylindrical pleated filter of charged layered membrane filter material during attachment of the housing to a threaded connection. A secondary filter media may be disposed within the tube.

The charged layer membrane filter material may be characterized by having a about a 50 μV positive charge over the entire internal media area, possessing about 90% porosity through 2μ, pores and containing about 32% by weight fine powdered activated carbon in about 1 mm thick cellulosic-polyethylene stock.

In general, in another aspect, a filter element is a cylindrical pleated filter of charged layer membrane filter material including a filter diameter, a number of pleats and a pleat width resulting in the outer pleat apex included angle of each pleat being at least 10-degrees.

In general, in another aspect, a filter element and assembly including the same is provided. The filter element is a cylindrical pleated filter of charged layer membrane filter material wherein the outer pleat apex included angle of each pleat is at least 10-degrees and the width of each pleat is between 6 and 31% of the filter diameter. A housing is removably attached to a bottle top and the housing supports the cylindrical pleated filter of charged layer membrane filter material.

In embodiments an extension tube removably connects the housing to the bottle top. In embodiments, the extension tube positions the housing towards the bottom of a bottle to which the bottle top is secured. In embodiments the housing is external so the cylindrical pleated filter of charged layer membrane filter material and includes one or more base positioned water inlets to the housing.

In embodiments the filter element and assembly further include a pair of end caps one potted to each end of the cylindrical pleated filter of charged layer membrane filter material and the housing connecting to the pair of end caps. The housing may be reversibly connectable to the pair of end caps.

In general, in another aspect, a filter element and assembly including the same is provided. The filter element is a cylindrical pleated filter of charged layer membrane filter material wherein the outer pleat apex included angle of each pleat is at least 10-degrees and the width of each pleat is between 6 and 31% of the filter diameter. A housing is configured for inline connection and the cylindrical pleated filter of charged layer membrane filter material received within said housing.

The charged layer membrane filter material may be characterized by having about a 50 μV positive charge over the entire internal media area, possessing about 90% porosity through 2μ, pores and containing about 32% by weight fine powdered activated carbon in about 1 mm thick cellulosic-polyethylene stock.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a table of filter performance test results of a cylindrical pleated filter of charged layer membrane filter material;

FIG. 2 is a diagram illustrating mathematical relationships between elements of a cylindrical pleated filter:

FIG. 3 is a diagram illustrating mathematical relationships between elements of a filter pleat;

FIG. 4 is a table of model calculations of a cylindrical pleated filter with a 31 mm base diameter illustrating the effect of outer pleat apex included angle, pleat width, pleat number, media thickness and occlusion;

FIG. 5 is a table of model calculations of a cylindrical pleated filter with a 49 mm base diameter illustrating the effect of outer pleat apex included angle, pleat width, pleat number, media thickness and occlusion;

FIG. 6 is a table illustrating test results of a filter construction tested at a flow rate of 10 ml/sec;

FIG. 7 is a performance comparison of the test results illustrated in the table of FIG. 6;

FIG. 8 is a table of test result of another filter construction tested at a flow rate of 10 ml/sec;

FIG. 9 is a diagrammatic view of an exemplary water bottle having an exit water filter comprising a pleated cylindrical filter of CLM filter material;

FIG. 10 is a diagrammatic view of another exemplary water bottle having an exit water filter comprising a pleated cylindrical filter of CLM filter material;

FIGS. 11a-11c are diagrammatic views of a reversible/interchangeable filter housing and pleated cylindrical filter of CLM material, wherein:

FIG. 11a illustrates a first configuration;

FIG. 11b illustrates a second configuration; and

FIG. 11c illustrates an enlarged partial view of a connection between filter elements; and

FIG. 12 is a diagrammatic view of an exemplary inline water filter comprising a pleated cylindrical filter of CLM filter material.

### DETAILED DESCRIPTION OF THE INVENTION

Embodiments of the present invention relate to improved pleated cylindrical filter cartridge constructions, and more particularly, to improved pleated filter cartridge constructions of Charged Layer Membrane (CLM) filter media for use in connection with portable drinking devices. Most specifically, embodiments of the present invention include pleated filter cartridges of CLM filter material and methods of manufacture of the same achieving filtering performance that heretofore has not been achieved with pleated filter cartridges of CLM filter material.

The initial experience with charged layer membrane filter media in a pleated cylindrical form suitable for use as a filter in a portable drinking device, such a sports bottle or hydration pack, unexpectedly failed to meet anticipated performance based upon published test sheet stock results of the charged layer membrane filter media.

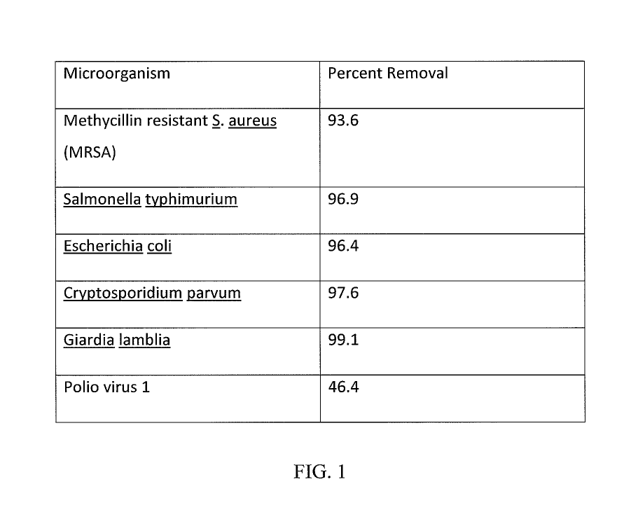

Performance results of a second generation pleated cylindrical filter cartridge fabricated from commercially available charged layer membrane filter media for a filter cartridge of 30.5 mm in diameter, by 37.33 mm in length and including 24 pleats of, 7 mm depth were encouraging. The performance results of this pleated cylindrical filter are cartridge shown in Table 1 illustrated in FIG. 1. This table represents percentage of contamination removal at a flow rate of 8.3 ml/sec.

While these results are not as good as desired, they are significantly better than earlier results. The unexpected performance of the pleated cylindrical filter fabricated from the CLM filter media being far lower than the test results reported for flat sheets of this media, prompted an analysis of the sensitivity of the performance to the physical characteristics of the filters induced by the manufacturing process as well as mode of application.

Based on the analysis of the pleated filter cartridge related to Table 1 testing, it was thought that there were several potential reasons for the depreciated performance of the pleated filter products over the test results reported for flat sheet stock. There were the obvious problems of potting the open ends of the filter media in the top and base housings, structural problems which occurred stressing the media during the pleating operation, and issues with the method used to join the pleated strip ends into a cylindrical configuration. An unrecognized problem became apparent that in the quest for maximum filter surface area the pleats are functionally compressed one against the other. As a result resistance to flow through much of the surface area is increased, and flow is concentrated through the apexes of the internal pleat folds, hence increasing the velocity of water through a reduced area.

This unrecognized problem was discovered by modeling a pleated cylindrical filter cartridge and a pleat of the pleated filter cartridge in order to determine a mathematical relationship between the various dimensional variables of the a pleated filter cartridge. It is believed the efforts herein are the first at modeling a pleated filter cartridge for the purpose of determining relationship between filter cartridge performances and filter cartridge and pleat dimensions.

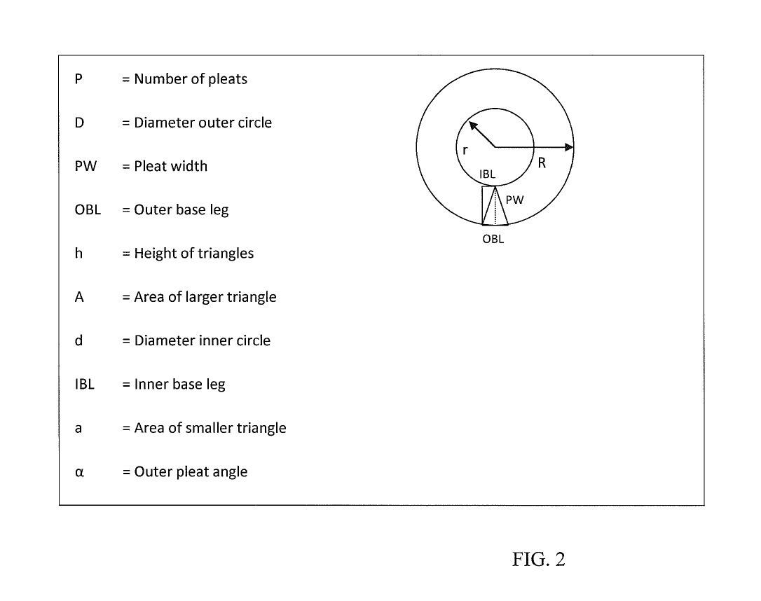

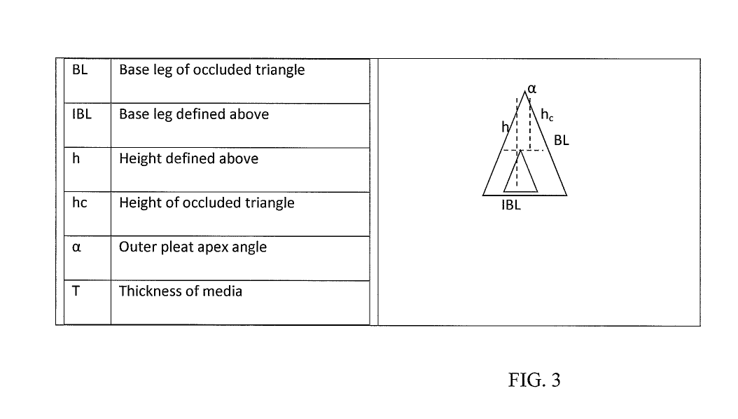

Now with reference to FIGS. 2 and 3, a mathematical relationship between filter diameter, pleat width, and the number of pleats has been derived as follows:

Defining the outer circumference of the filter as contiguous segments corresponding to the base of P triangles with sides OBL and PW,

$$OBL = \frac{π D}{P} \qquad ( Eqn . 1 )$$

with the height of the triangles given by the Pythagorean Theorem

$$h = \sqrt{{PW}^{2} - \frac{OBL}{{2}^{2}}} \qquad ( Eqn . 2 )$$

and area described by the formula:

A=½OBL·h (Eqn. 3)

Repeating the above process; defining the inner circumference inscribed by the inner filter pleats as contiguous segments corresponding to the base of P triangles with sides IBL and PW,

$$IBL = \frac{π d}{P} \qquad ( Eqn . 4 )$$

with the area of these smaller triangles described by:

$$a = \frac{1}{2} IBL \cdot h or IBL = \frac{2 a}{h} \qquad ( Eqn . 5 )$$

Combining Equations 4 and 5 yields:

$$\frac{2 a}{h} = \frac{π d}{P} or d = \frac{2 a \cdot P}{π h} \qquad ( Eqn . 6 )$$

Combining Equations 5 and 6 yields:

$$d = \frac{2 aP}{π \sqrt{{PW}^{2} - \frac{OBL}{{2}^{2}}}} \qquad ( Eqn . 7 )$$

Describing the area of the sum of the larger and smaller triangles as related to the annulus between the two circumferences,

$$π ( {( \frac{D}{2} )}^{2} - {( \frac{aP}{π \sqrt{{PW}^{2} - \frac{OBL}{{2}^{2}}}} )}^{2} ) - P \cdot A = P \cdot a$$

and solving for the area of a single smaller triangle,

$$a = \frac{1}{8 {P}^{2}} ( \pm \sqrt{π} \cdot \sqrt{( {P}^{2} ( 4 {PW}^{2} - {OBL}^{2} ) ( - 16 A \cdot P + 4 π {D}^{2} + 4 π {PW}^{2} - π {OBL}^{2} ) ) - 4 π P \cdot {PW}^{2} + π P \cdot {OBL}^{2}} )$$

with the restrictions

P≠0

4PW²−OBL²≠0

allows us to solve for the outer pleat angle by applying the SAS Theorem to describe the area of a right triangle by

a=½PW² sin(α)

and rearranging:

$$α = {sin}^{- 1} ( \frac{2 a}{{PW}^{2}} )$$

Using the feasible solution for the area of the smaller triangle allows us to solve for the outer pleat angle as a function of the number of pleats, diameter of the filter, and length of the pleats.

The amount by which the pleats are compressed together can similarly be determined. As the pleats become more crowded the surfaces of adjacent membrane layers begin to make contact with each other near the pleat, occluding this area from free contact with the water being treated. This occlusion is a function of pleat width, media thickness, and the pleat outer apex included angle. In the previous derivations it was assumed that the media surfaces were modeled as if consisting of a plane drawn half way through the center of the filter cloth, thus the pleat becomes occluded at the critical height where the base leg (BL) of the triangle model equals the thickness of the media.

BL=T→h_{c}

Since we know the outer pleat angle from the previous derivation we can calculate the critical height

$${h}_{c} = \frac{T}{2 tan ( \frac{α}{2} )}$$

and define the percent occlusion by

$$occlusion = \frac{area\_occluded}{total\_area} \times 100$$

$$occlusion = \frac{\frac{1}{2} \cdot T \cdot \frac{T}{2 tan ( \frac{α}{2} )}}{\frac{1}{2} \cdot IBL \cdot h}$$

or
simplifying to:

$$occlusion = \frac{{T}^{2}}{2 \cdot IBL \cdot tan ( \frac{α}{2} )} \times 100$$

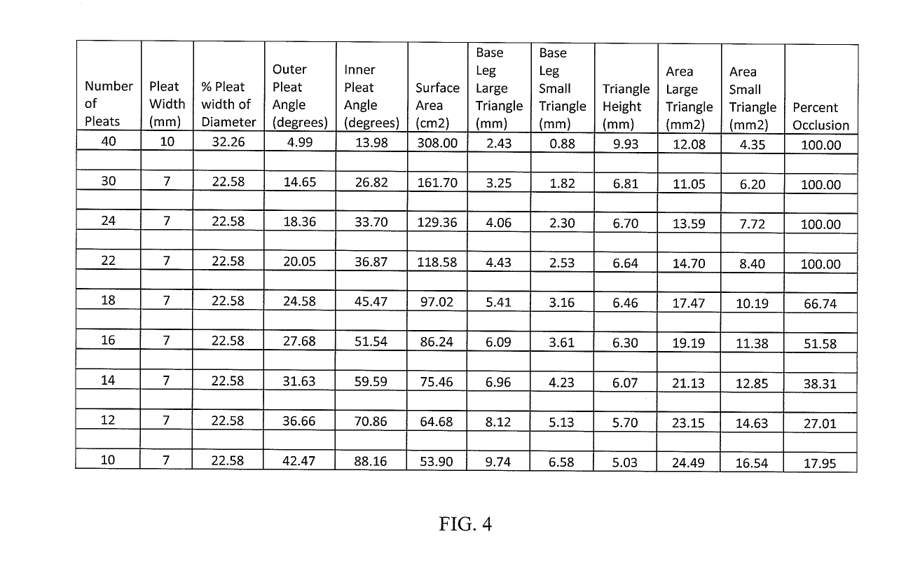

Table 2, illustrated in FIG. 4, shows relational data of outer pleat apex included angle and percentage of pleat occlusion relative to a filter diameter of 31 mm and a number of pleats and pleat width.

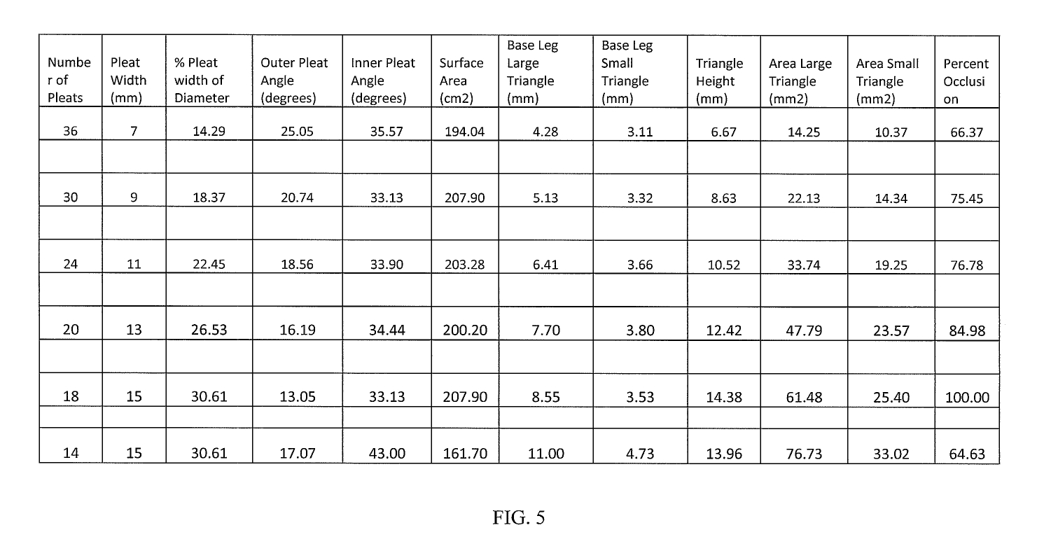

Table 4, illustrated in FIG. 5, shows relational data of outer pleat apex included angle and percentage of pleat occlusion relative to a filter diameter of 49 mm and at a number of filter pleats and pleat width.

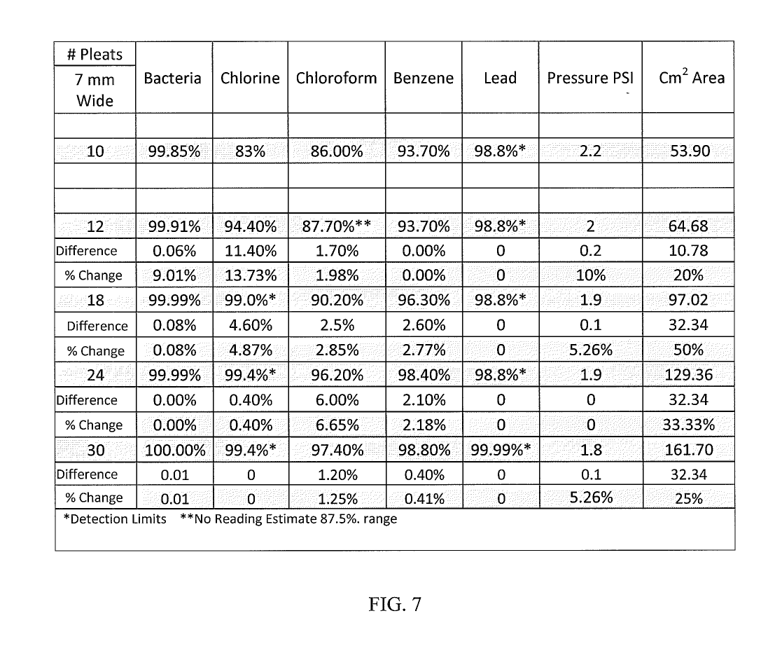

In two representative filter diameters of 31 and 49 mm diameter with filter lengths of 38.5 mm we see that the percent occlusion increases as the number of pleats increases. The consequence of this occlusion will become apparent when we discuss the relationship between filter surface area and removal efficiency for specific contaminants as presented in Table 4, illustrated in FIG. 7.

As discussed above, CML filter material function less by size exclusion of contaminant particles by pore size in the membrane and more by the overlap of the surface charges. The overlap of these charges provides an effective pore radius which is much smaller than the actual pore size of the membrane. As such, retention of particles in the membrane by ion exchange and charge attraction is sensitive to flow rate and may be subject to charge saturation. Increasing flow through the inner crease of the pleat therefore affects filter performance both because of ionic effects and the fact that damage to the membrane may occur here in the pleating process.

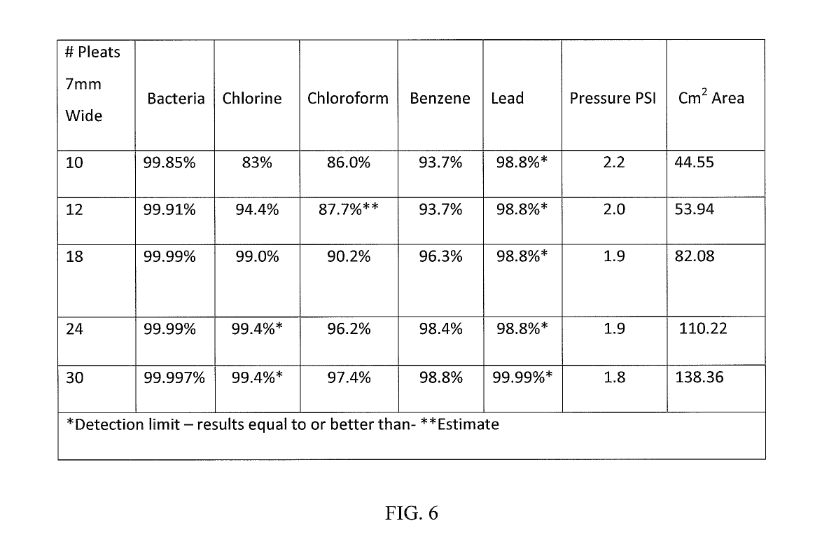

The test results shown in Table 3, illustrated in FIG. 6, are examples of the testing differentials as varied by the number of pleats employed using a constant 7 mm wide pleat and a standard exposed media length of 38.5 mm. These tests have been performed on filters embodying the principals of the present invention. Table 3 illustrates the functional relationship in contaminant removal as a result of surface area change (as a function of pleat number) and at a constant flow of 10 ml/sec; and the effect of surface area upon pressure.

The test results reported in Table 3 were obtained with filters of 31 mm diameter, 38.5 mm accessible media length and 7 mm pleat width (depth). Testing with filters produced by us using our manufacturing techniques and product designs has shown that all filter pleat configurations reduced protozoan cyst concentrations by 99.9% or more. Thus, the above table was tabulated relative to bacteria and chemical content in highly viable commercial filter configurations.

The elevated pressure and slightly poorer results with the smaller surface area within the filter is indicative of the increased velocity of the water through a smaller area to retain the flow at 10 ml/sec. It is also noted that the reduction of pressure is much less than linear, as one might otherwise anticipate, as with the increase of pleats to achieve additional surface area less internal area is available on a percentile basis for water flow with a degree of blockage taking place.

Table 4, illustrated in FIG. 7, shows the change in contaminate removal performance and pressure drop as the outer apex angle is decreased. The resistance to flow climbs as the performance benefits of additional surface area decreases.

The significance and purpose of Table 4 is to equate the performance, with pressure drop, and the surface area. The light shaded data shows the performance of the particular number of pleats specified. The white line below the light shaded area is the numerical change from the preceding pleat results, the differential gained by increasing the number of pleats and surface area over the preceding lesser number of pleats. Further illustrated is the percentage of change in performance as well as surface area from the previous lesser number of pleats. This data is highly significant showing a grossly reduced percentage of increased performance relative to the percentage increase in filter surface area as the occlusion within the pleats increases. The pleats were retained at a width of 7 mm throughout as was the test flow of 10 ml/sec. The only change being the number of pleats and surface area. As previously shown there is a greater occlusion of the inner pleat surface with the decrease in outer apex angle as occurs as the number of pleats is increased. Thus, the percentage improvement also diminishes moving toward the point of depreciation rather than appreciation of performance.

The results shown in Table 4 for the 10 pleat essentially are not satisfactory for other than a taste and odor filter, although still rather spectacular in comparison with a carbon block filter. Performance is less as the constant flow rate, when divided over the available surface area, is too great reducing residence time and enhancing the water shear thus reducing performance.

Considering filters with from 12 pleats through 30 pleats, the more viable commercial configurations providing various levels of performance, we see that with the 18 pleat filter we have a maximum improvement of performance of 4.87% while we increased the surface area by 50% over the 12 pleat filter. Similarly, with the 24 pleat filter we have a maximum improvement of 6.65% vs. an increase in surface area of 33.33% over the 18 pleat filter. Again with a 30 pleat filter we have a maximum improvement of 1.25% for contaminant reduction vs. a 25% increase in surface area vs. the 24 pleat filter. Aside from contaminant reduction we have the question of pressure differential, or pressure reduction as surface area is increased. This ranged in decreases of 10% to 5.26%, between filters tested, much less than the increase in surface area should dictate. All of which is attributed to reduced efficiency as the outer apex angle is decreased and the inner water flow area within the pleats available for water flow reduced.

The outer apex angle is a function of the filter diameter, pleat width, and number of pleats. This may be stated more succinctly as the outer apex angle being dependent on the number of pleats and the ratio between the pleat width and diameter of the filter. For the two filter diameters described in this paper, with pleat widths ranging from 7-10 mm in the 31 mm diameter and 7-15 mm in the 49 mm diameter filters, the proportion of pleat width to filter diameter rages from 6.38 to 53.16%. This relationship is fully scalable, and not restricted to filters of 31 and 49 mm diameters.

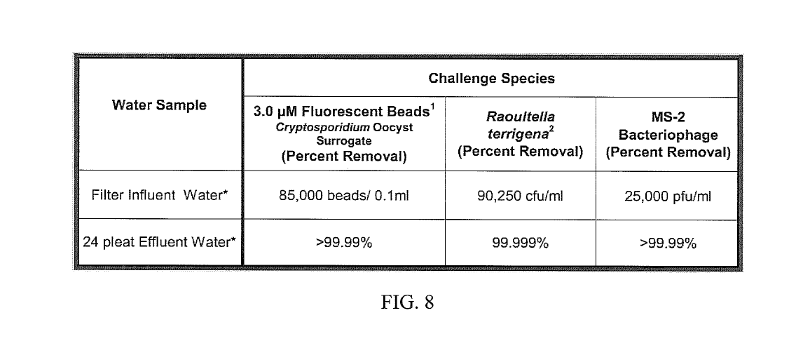

Testing was also performed on a 24 pleat CLM filter, 31.5 mm diameter filter 55.6 mm in length with a pleat width of 7 mm and an exposed surface area of 183 cm², that with a flow rate of 10 ml/sec tested within 0.0009% of the EPA recommendation for the removal of bacteria while exceeding the requirements for protozoa and virus reduction. This testing was conducted by a registered third party laboratory with the results as represented in Table 5, illustrated in FIG. 8.

It has also been determined that the CLM provides sufficient rigidity without an internal or external support connecting the top and bottom housings provided the filter is installed by grasping the top housing while assembling the filter to the top or exit end of the water filter. However, for standard applications an external housing connecting cylinder is used which is potted into the top and bottom housings. The outer connecting housing is also a functional component providing a variety of water openings which again differentiate the products of various customers as well as to control how the water enters and is dispersed about the filter media. Alternatively, when an outer housing is used the water entry port could be located only at the top or the base of the housing permitting maximum water removal with even distribution over the surface of the exposed CLM media. This outer housing could also be removable and reversible changing water intake from the top of the filter to the base, or visa versa, allowing the filter to be used either fitted to the bottle top or to a straw with the filter positioned at the bottom of the bottle.

A third alternative is the inclusion of a center tube which may be used to strengthen the filter assembly joining the top and base housings. Also, the center tube may be employed to house a second different media such as an alkalizing media, arsenic specific media, or other ion-exchange product which functions preferably under an axially flow over the entire tube/media length.

The need for filters to accommodate a wide range of needs as well as to meet specific market price points, with functional filters, has led to the development of an array of filters that are differentiated by the number of pleats and the depth of pleats within specific diameter and length standards. Aside from the fixed low costs of the filter housings the media, the CLM, is the most costly element and thus offers the opportunity for competitive pricing by adjusting the media area employed in accordance with the stated filter requirements.

As such, in embodiments filters are provided with pleat configurations of 30, 28, 26, 24, 20, 18, 16, 14, 12, and 10 with effective filter lengths produced to individualize the filters for specific customer identity purposes. The pleat width may vary from a minimum of 7 mm to a maximum of 10 mm based upon a 31 mm diameter and from 7 mm to 15 mm width when applied to a 49 mm diameter filter. Pleat width is varied together with the number of pleats to achieve the filter area deemed necessary to achieve the desired filter performance at specific flow rates and pressure drops for a given filter length. Other diameters would be varied accordingly.

Performance must be assessed at a specific flow rate for a given amount of filter media. Experience has shown that 10 ml/sec is deemed adequate by most users of filter bottles and represents the average quantity a user swallows at one time. However, it is also recognized the desire for rapid hydration; thus, embodiments include up to 265 cm2 surface area to treat a flow of 15-20 ml/sec with acceptable results.

Embodiments include a 31 mm diameter filter with outer pleat apex angles equal to or greater than 14-degrees with a minimum pleat width of 7 mm and with between 10 and 30 pleats, other factors remaining constant, providing available surface areas from 161.7 cm2 to 53.9 cm2 with a 38.5 mm functional filter length.

As the pleat numbers are diminished it is practical to increase the pleat width, decreasing the number of pleats and thus pleat apex's which have proven to be the area most prone for bypass failure. Thus, it is desirable from a performance stand point to maximize the pleat width, or depth, while minimizing the number of pleats providing the area commensurate with the performance required, the flow rate, and pressure drop. The product's useful life expressed in liters of water that may be processed as well as cost to produce are the remaining driving factors. While increasing the width of the pleats is desirable from a surface area standpoint, an optimum value exists where compromise of performance due to pleat occlusion doesn't balance the benefits from increasing pleat width.

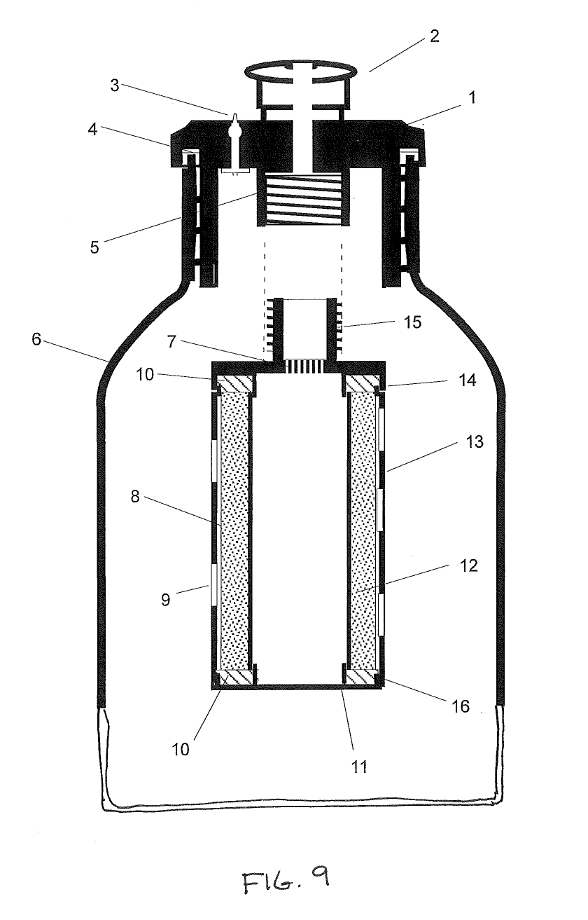

With reference now to FIG. 9, there is diagrammatically illustrated an exemplary water bottle having an exit water filter comprising a pleated cylindrical filter of CLM filter material according the invention.

The bottle 6, the bottle top 1, with valve 2 and air vent 3, seal 4, with the filter connecting threaded boss 5. The filter side housing 13, with water entry ports 9 and inner tabs 16 which are secured by the potting compound 10, assembles to the base housing 11, and the top housing 14, containing molded screen 7. The CLM pleated filter 12 is retained and sealed to the end caps by the potting compound 10, there is a small water space 8, between the apex of the pleats formed into the CLM filtration media 12, and the outer housing section 13 which is an independent component from the top housing 14, and base housing 11.

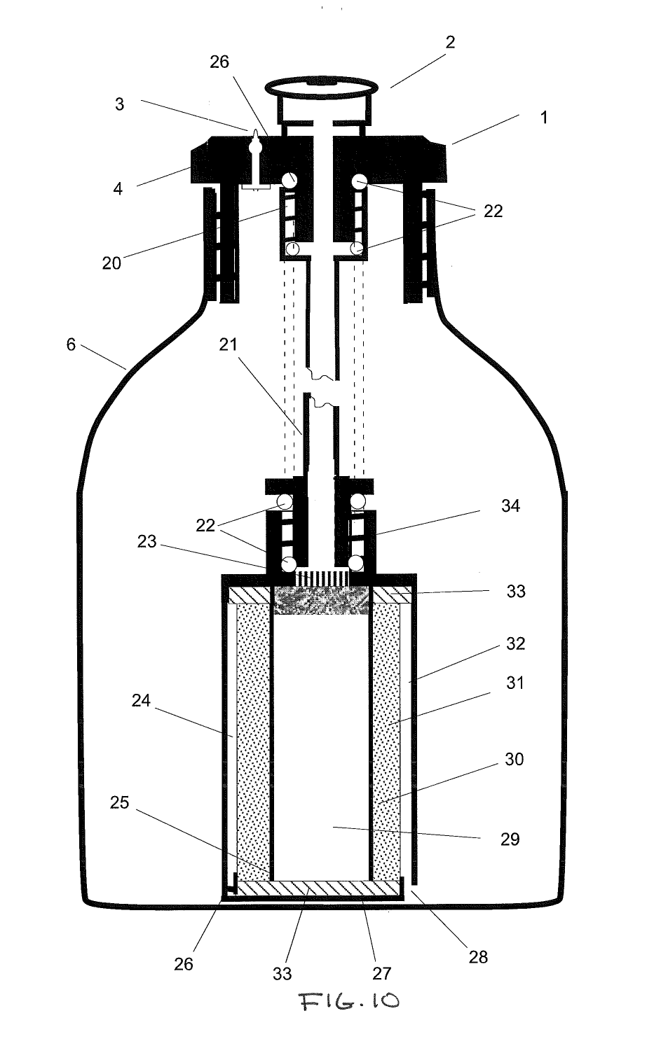

With reference to FIG. 10 there is diagrammatically illustrated another exemplary water bottle having an exit water filter comprising a pleated cylindrical filter of CLM filter material according the invention.

A similar filter adapted for use when mounted in a water bottle 6 in an upright attitude, with top 1, valve 2, breathing valve 3 O-ring seals 26, and threaded boss 20. The filter housing 29 fastens to the connecting tube 21, by the threaded connecting boss 34 and to the threaded boss 20, on bottle cap 1. O-ring seals 22 preclude seepage from untreated water. The upper filter housing 29 contains the mounting boss 34 and integral housing side 32 which has intermittent openings at the base 28, for water entry. Space 24 between the filter 30 and housing 32 permits the water to be drawn up accessing the entire external filter 30, surface to facilitate passage through to the filter. The filter 30 is secured to the base 27 by potting compound 33, which is fastened to the housing side wall 32 by a locking snap ring 26. An optional media may be added for alkalizing the water, or the removal of arsenic, or other heavy metals by using the internal space 34, and adding a flow redirecting tube 25, with base openings 35, the water flowing down by means of the open internal pleats to the base of the filter 30, to exit axially up through the optional media within center compartment 34, hence through screen 23, tube 21, and valve 2.

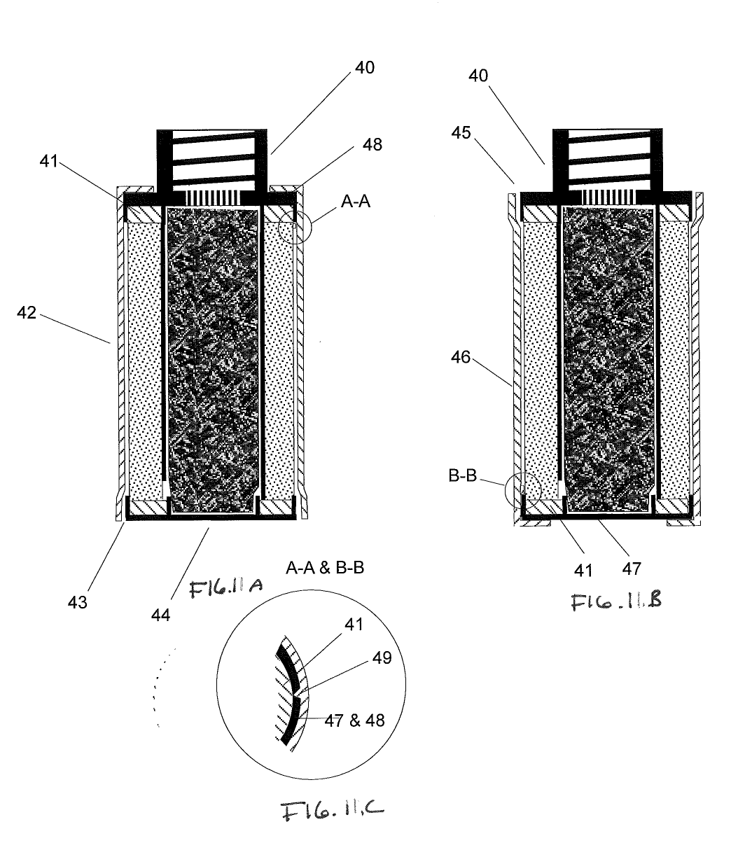

With reference to FIGS. 11a-11c there is diagrammatically illustrated is reversible/interchangeable filter housing and pleated cylindrical filter of CLM material according the invention, where FIG. 11a illustrates a first configuration and FIG. 11b illustrates a second configuration.

An interchangeable filter housing component 42 when affixed to a filter designed to be placed at the bottom of a bottle (FIG. 11a) or 46 when affixed to a filter designed to be mounted to the bottle's valved cap (FIG. 11b). The filter when positioned at the base of the bottle A, shows the filter 40 and filter housing top 48 over which center housing 42 is placed with a friction fit; and radial engagement as shown at 49, a slot molded into the housing 48 (FIG. 11c) where a vertical ridge molded into the center housing 42 engages the top 48 to allow the center housing 42 to add torque to the filter 40 when assembled to the bottle cap (not shown). 41 represents potting compound, 43 the opening for water entry between the central housing 42 and filter base 44. The functions of the central housing 46 in sub FIG. 3B are identical, just reversed with the central housing 46 fitting over the base 47, which is also slotted a per the exploded view BB with opening 34 toward the top of filter 40 designed to fit to the valved bottle top, not shown.

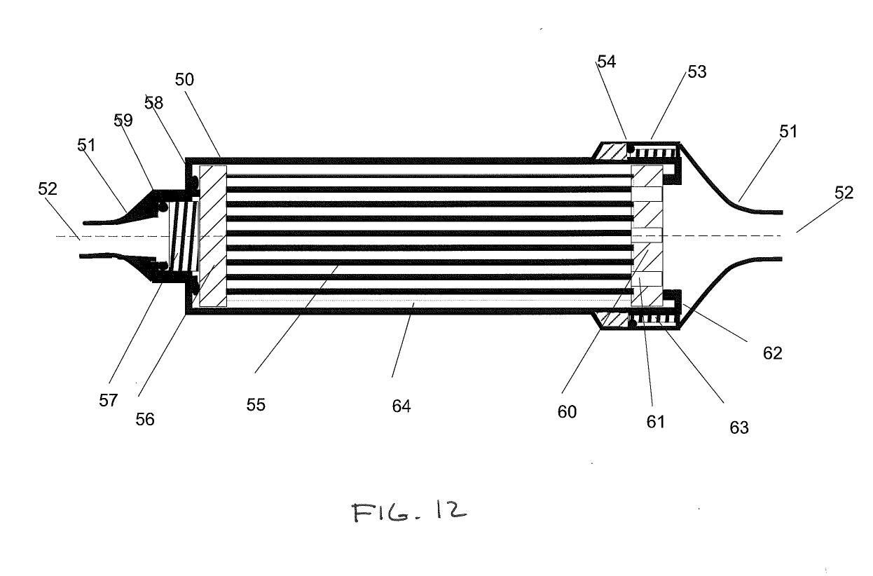

With reference to FIG. 12 there is diagrammatically illustrated an exemplary inline water comprising a pleated cylindrical filter of CLM filter material according the invention.

In-line filter which may use existing or modified end caps from the bottle filters with lengthened bodies to provide additional filtration surface area is provided. The housing 50 and 53 thread together incorporating O-ring seal 54, encapsulating the filter body 55 supported between end caps 56 and 60; threaded into the housing exit port section 51 by the threaded connection 57 and sealed by O-rings 56 and 59; the in-let end cap 53 contains positioning legs 62 assuring that the filter assembly has been fully threaded to the exit housing; the in-let filter end plate has sculptured reliefs 61 to permit the flow of incoming water into the external surfaces of filter 55 as shown as 64; the water enters at 52 through a tube not shown but fastened to surface 51 and after passing through the filter media 55 exits through port 52; typically into a tube attached to surface 51.

A number of embodiments of the present invention have been described. Nevertheless, it will be understood that various modifications may be made without departing from the spirit and scope of the invention. Accordingly, other embodiments are within the scope of the following claims.

1. A filter element comprising:
a cylindrical pleated filter of charged layer membrane filter material having a filter diameter, a number of pleats, each pleat having an outer apex included angle and a width, wherein the outer pleat apex included angle of each pleat is at least 10-degrees and the width of each pleat is between 6 and 31% of the filter diameter.

2. The filter element of claim 1, wherein the outer pleat apex included angle of each pleat is at least 13-degrees.

3. The filter element of claim 1, wherein the filter diameter is about 31 mm and includes 30 or less pleats.

4. The filter element of claim 1, wherein the filter diameter is about 49 mm and includes 36 or less pleats.

5. The filter element of claim 1, further comprising:
a housing containing said cylindrical pleated filter of charged layer membrane filter material.

6. The filter element of claim 5, further comprising:
a tube positioned interiorly of said cylindrical pleated filter of charged layer membrane filter material and connected to said housing so as to prevent an application of torque to said cylindrical pleated filter of charged layer membrane filter material during attachment of said housing to a threaded connection.

7. The filter element of claim 6, further comprising:
a secondary filter media disposed within said tube.

8. The filter element of claim 1, wherein said charged layer membrane filter material is characterized by having a about a 50 μV positive charge over an entire internal media area, possessing about 90% porosity through 2μ pores and containing about 32% by weight fine powdered activated carbon in about 1 mm thick cellulosic-polyethylene stock.

9. (canceled)

10. A filter element and assembly including the filter element, comprising:
a cylindrical pleated filter of charged layer membrane filter material having a filter diameter, a number of pleats, each pleat having an outer apex included angle and a width, wherein the outer pleat apex included angle of each pleat is at least 10-degrees and the width of each pleat is between 6 and 31% of the filter diameter;
a housing removably attached to a bottle top; and
said housing supporting said cylindrical pleated filter of charged layer membrane filter material.

11. The filter element and assembly of claim 10, further comprising:
an extension tube removably connecting said housing to said bottle top.

12. The filter element and assembly of claim 11, wherein said extension tube positions said housing towards a bottom of a bottle to which said bottle top is secured.

13. The filter element and assembly of claim 10, wherein said housing is external to said cylindrical pleated filter of charged layer membrane filter material and includes one or more water inlets to said housing.

14. The filter element and assembly of claim 10, further comprising:
a pair of end caps one potted to each end of said cylindrical pleated filter of charged layer membrane filter material; and
said housing connecting to said pair of end caps.

15. The filter element and assembly of claim 14, wherein said housing is reversibly connectable to said pair of end caps.

16. A filter element and assembly including the filter element, comprising:
a cylindrical pleated filter of charged layer membrane filter material having a filter diameter, a number of pleats, each pleat having an outer apex included angle and a width, wherein the outer pleat apex included angle of each pleat is at least 10-degrees and the width of each pleat is between 6 and 31% of the filter diameter;
a housing configured for inline connection; and
said cylindrical pleated filter of charged layer membrane filter material received within said housing.

17. The filter element and assembly of claim 16, wherein said charged layer membrane filter material is characterized by having a about a 50 μV positive charge over an entire internal media area, possessing about 90% porosity through 2μ pores and containing about 32% by weight fine powdered activated carbon in about 1 mm thick cellulosic-polyethylene stock.
